(19) United States
(12) Patent Application Publication
(10) Pub. No.: US 2013/0202210 A1
(43) Pub. Date: Aug. 8, 2013

(54) METHOD FOR HUMAN ACTIVITY PREDICTION FROM STREAMING VIDEOS

(71) Applicant: Electronics And Telecommunications Research Institute, Daejeon (KR)

(72) Inventors: Michael Sahngwon RYOO, Daejeon (KR); Jae-Yeong LEE, Daejeon (KR); Wonpil YU, Daejeon (KR)

(73) Assignee: ELECTRONICS AND TELECOMMUNICATIONS RESEARCH INSTITUTE, Daejeon (KR)

(21) Appl. No.: 13/654,077

(22) Filed: Oct. 17, 2012

(30) Foreign Application Priority Data
Feb. 8, 2012 (KR) 10-2012-0013000

(51) Int. Cl. G06K 9/46

(52) U.S. Cl. 382/195

(57) ABSTRACT

A method for human activity prediction from streaming videos includes extracting space-time local features from video streams containing video information related to human activities; and clustering the extracted space-time local features into multiple visual words based on the appearance of the features. Further, the method for the human activity prediction includes computing an activity likelihood value by modeling each activity as an integral histogram of the visual words; and predicting the human activity based on the computed activity likelihood value.

### CROSS-REFERENCE TO RELATED APPLICATION(S)

The present invention claims priority of Korean Patent Application No. 10-2012-0013000, filed on Feb. 8, 2012, which is incorporated herein by reference.

### FIELD OF THE INVENTION

The present invention relates to a method for predicting human activity from streaming videos; and more particularly, to a method for recognizing a dangerous accident in an early stage by predicting human activities from video images.

### BACKGROUND OF THE INVENTION

Human activity recognition is a technology of automatically detecting human activities observed from a given video. The human activity recognition is applied to surveillance using multiple cameras, dangerous situation detection using a dynamic camera, human-computer interface, and the like.

Most of current human activity recognition methodologies introduced focus only on detection of activities (actions, behaviors) after such activities or accidents have been completely finished. The recognition is performed merely after obtaining video information (streaming videos) containing the entire activities. This may be considered as an after-the-fact detection.

However, it is important to prevent dangerous activities and accidents such as crimes or car accidents from occurring, and the recognition of such activities after occurred is insufficient.

Since the conventional techniques aim for the after-the-fact recognition with respect to finished human activities, however, the recognition is not carried out before finished activities or accidents are observed. Consequently, such conventional technologies are unsuitable for a surveillance system for preventing theft, a car accident preventing system or the like, and development of a new early accident prediction and recognition technology is required.

### SUMMARY OF THE INVENTION

In view of the above, the present invention provides a method for recognizing human activity in an early stage by executing a human activity prediction through detection of an early part of activities and accident from insufficient video information at a point of time as early as possible (that is, at an initial point of time when the accident is occurring).

In accordance with an embodiment of the present invention, there is provided a method for human activity prediction from streaming videos. The method includes extracting space-time local features from video streams containing video information related to human activities; clustering the extracted space-time local features into multiple visual words based on the appearance of the features; computing an activity likelihood value by modeling each activity as an integral histogram of the visual words; and predicting the human activity based on the computed activity likelihood value.

Further, said extracting space-time local features may include detecting interest points with motion changes from the video streams and computing descriptors representing local movements.

The visual words may be formed from features extracted from a sample video by using a K-means clustering algorithm.

Further, said computing an activity likelihood value may include computing a recursive activity likelihood value by updating likelihood values of the entire observations using likelihood values computed for previous observations.

Furthermore, said computing an activity likelihood value may further include computing the recursive activity likelihood value by dividing image frames of the video streams into several segments with a fixed duration and dynamically matching the divided segments with activity segments.

In accordance with the embodiments of the present invention, human activities can be recognized in an early stage by executing the human activity prediction through detection of the early part of activities and accident merely from rather insufficient video information at a point of time as early as possible (that is, at the initial point of time when the accident is occurring).

Thus, it is possible to detect and cope with crimes or dangerous activities which are not occurring yet or have not completely finished yet based on video information. In addition, socially important crimes or abnormal behaviors can effectively be prevented by virtue of generation of warning in an early stage.

### BRIEF DESCRIPTION OF THE DRAWINGS

The above and other objects and features of the present invention will become apparent from the following description of embodiments, given in conjunction with the accompanying drawings, in which:

FIGS. 1A and 1B are examples illustrating a human activity post-recognition method for helping understanding a human activity prediction method in accordance with an embodiment of the present invention;

FIGS. 2A and 2B respectively illustrate examples of features extracted from a sample video and visual words formed from the features in accordance with the embodiment of the present invention;

FIGS. 3A and 3B respectively illustrate examples of observed videos and integral histograms in accordance with the embodiment of the present invention;

FIG. 4 is an example illustrating a process of updating likelihood of full observation using likelihood computed for previous observation in accordance with the embodiment of the present invention; and

FIG. 5 is an example illustrating a process of a dynamic programming algorithm for computing the likelihood of an ongoing activity from an incomplete video.

### DETAILED DESCRIPTION OF THE EMBODIMENT

Advantages and features of the invention and methods of accomplishing the same may be understood more readily by reference to the following detailed description of embodiments and the accompanying drawings. The invention may, however, be embodied in many different forms and should not be construed as being limited to the embodiments set forth herein. Rather, these embodiments are provided so that this disclosure will be thorough and complete and will fully convey the concept of the invention to those skilled in the art, and the invention will only be defined by the appended claims.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms need to be defined throughout the description of the present invention.

The present invention is to perform an early prediction, rather than a post-recognition, for human activity or accident. In a real-time system, such as surveillance or the like, videos are continuously provided to the system in the form of stream. The system has to detect activities or accidents from such video streams. Here, ongoing activities or accident should be predicted as early as possible so as to be handled.

To this end, a probabilistic formulation has been established as a concept called a human activity prediction. To implement this formulation, features called spatio-temporal features associated with local movements have been extracted from videos, and methodologies such as integral bag-of-words and dynamic bag-of-words, which use the features, have been designed. These two types of methodologies commonly use an integral histogram. That is, the early prediction for activities or accidents is realized by using the integral histogram which represents distribution of the spatio-temporal features.

Hereinafter, embodiments of the present invention will be described in detail with reference to the accompanying drawings which form a part hereof.

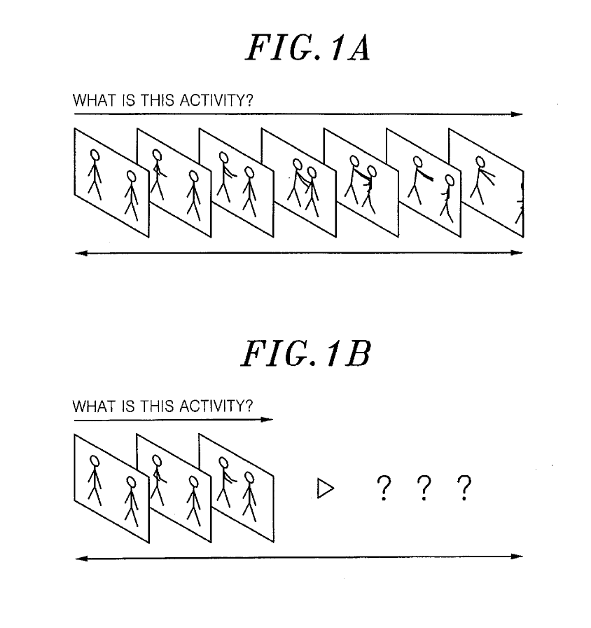

FIG. 1 is an example illustrating a human activity post-recognition method for helping understanding a human activity prediction method in accordance with an embodiment of the present invention.

FIG. 1A illustrates an example of a human activity post-recognition method. In this method, when a video showing a specific human activity is input, the video is analyzed to categorize the human activity based on the analysis result, so as to recognize which activity has occurred.

FIG. 1B illustrates an example of a human activity prediction method. In this method, when a video having information related to activities until before a specific human activity is made is input, the video is analyzed to predict which activity is to be made based on the analysis result.

Hereinafter, the human activity classification will be first briefly described and then the human activity prediction in accordance with an embodiment of the present invention will be described.

The goal of human activity classification is to categorize the given videos (i.e., testing videos) into a limited number of classes. Given an observation video ‘O’ composed of image frames from time 0 to t, the system is required to select an activity label Aₚ which the system believes to be contained in the video. Various classifiers including K-nearest neighbors (K-NHs) and support vector machines (SVMs) have been popularly used in previous approaches. In addition, sliding windows techniques have been often adopted to apply activity classification algorithms for the localization of activities from continuous video streams.

Probabilistically, the activity classification is defined as a calculation of the posterior probability of the activity Aₚ given a video ‘O’ with length t, which is calculated by the following Equation 1. In most cases, the video duration t is ignored, assuming it is independent to the activity.

$$\begin{matrix}P ( {A}_{p} \vert O , t ) = P ( {A}_{p} , {d}^{*} \vert O ) \\ = \frac{P ( O \vert {A}_{p} , {d}^{*} ) P ( {A}_{p} , {d}^{*} )}{{\sum }_{i}^{ } P ( O \vert {A}_{i} , {d}^{*} ) P ( {A}_{i} , {d}^{*} )}\end{matrix} \qquad [ Equation 1 ]$$

where d* is a variable describing the progress level of the activity, which indicates that the activity is fully progressed. As a result, the activity class with the maximum value P (Aₚ, d*|O) is chosen to be the activity of the video ‘O’.

The probabilistic formulation of activity classification implies the classification problem assumes that each video (either a training video or a testing video) provided to the system contains a full execution of a single activity. That is, it assumes the after-the-fact categorization of video observations rather than analyzing ongoing activities, and there have been very few attempts to recognize unfinished activities.

The problem of human activity prediction is defined as an inference of unfinished activities given temporarily in incomplete videos. In contrast to the activity classification, the system is required to make a decision on ‘which activity is occurring’ in the middle of the activity execution. In activity prediction, there is no assumption that the ongoing activity has been fully executed. The prediction methodologies must automatically estimate each activity's progress status that seems to be most probable based on the video observations, and decide which activity is most likely to occur at that time.

The activity prediction process may be probabilistically formulated by the following Equation 2,

$$\begin{matrix}P ( {A}_{p} \vert O , t ) = {\sum }_{d}^{ } P ( {A}_{p} , d \vert O , t ) \\ = \frac{{\sum }_{d}^{ } P ( O \vert {A}_{p} , d ) P ( t \vert d ) P ( {A}_{p} , d )}{{\sum }_{i}^{ } {\sum }_{d}^{ } P ( O \vert {A}_{i} , d ) P ( t \vert d ) P ( {A}_{i} , d )}\end{matrix} \qquad [ Equation 2 ]$$

where d is a variable describing the progress level of the activity Aₚ. For example, d=50 indicates that the activity Aₚ has been progressed from 0th frame to 50th frame. That is, it describes that the activity prediction process must consider various possible progress statuses of the activities for all 0≦d≦d*. P(t|d) represents the similarity between the length t of the observation and the length d of the activity progress.

The key of the activity prediction problem is the accurate and efficient computation of the likelihood value P(O|Aₚ,d), which measures the similarity between the video observation and the activity Aₚ having the progress level of d. A brute force method of solving the activity prediction problem is to construct multiple probabilistic classifiers (e.g., probabilistic SVMs) for all possible values of Aₚ and d. However, training and maintaining hundreds of classifiers to cover all progress level d (e.g., 300 SVMs per activity if the activity takes 10 seconds in 30 fps) requires a significant amount of computational costs. Furthermore, the brute force construction of independent classifiers ignores sequential relations among the likelihood values, making the development of robust and efficient activity prediction methodologies necessary.

The present invention introduces a human activity prediction methodology named integral bag-of-words. The major difference between the approach introduced in the present invention and the previous approaches is that the approach of the present invention is designed to efficiently analyze the status of ongoing activities from video streams.

To predict human activities in accordance with an embodiment of the present invention, three-dimensional (3D) space-time local features are used. A spatio-temporal feature extractor detects interest points with salient motion changes from a video, and provides descriptors that represent local movements occurring in the video. This spatio-temporal feature extractor converts a video into 3D XYT volume formed by concatenating image frames along time axis, and locates 3D volume patches with salient motion changes. A descriptor is computed for each local patch by summarizing gradients inside the 3D volume patch.

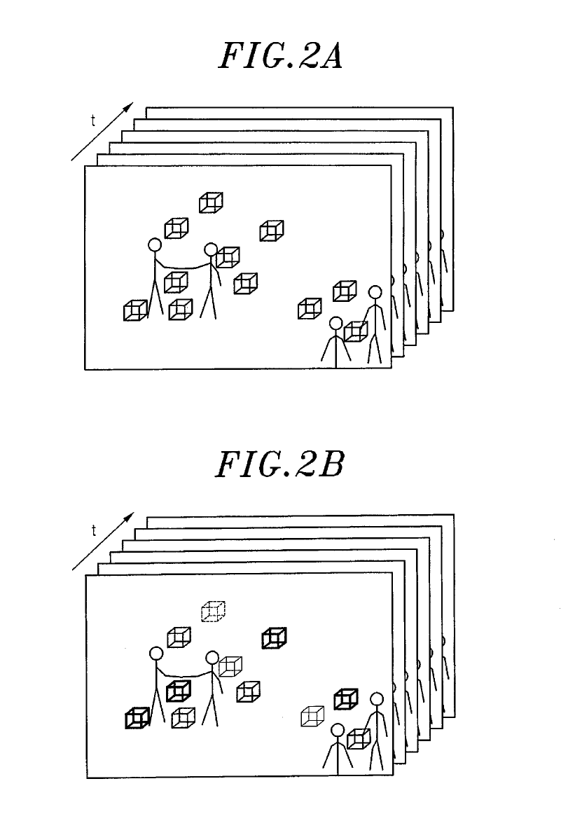

Once local features are extracted, the method in accordance with the present invention clusters them into multiple representative types based on their appearance (i.e., feature vector values). These types are called ‘visual words’, which essentially are clusters of features. The present invention uses k-means clustering algorithm to form visual words from features extracted from sample videos. As a result, each detected feature in a video belongs to one of k visual words. FIGS. 2A and 2B illustrate examples of features and visual words, respectively.

Integral bag-of-words is a probabilistic activity prediction approach that constructs integral histograms to represent human activities. In order to predict the ongoing activity given a video observation ‘O’ of length t, the system is required to compute the likelihood value P(O|Aₚ,d) for all possible progress level d of the activity Aₚ. What is presented herein is an efficient methodology to compute the activity likelihood value by modeling each activity as an integral histogram of visual words.

The integral bag-of-words method is a histogram-based approach, which probabilistically infers ongoing activities by computing the likelihood value P(O|Aₚ,d) based on feature histograms. The idea is to measure the similarity between the video ‘O’ and the activity mode (Aₚ,d) by comparing histogram representation therebetween. The advantage of the histogram representation is that it is able to handle noisy observations with varying scales. For all possible (Aₚ,d), this approach computes the histogram of the activity, and compares them with the histogram of the testing video.

A feature histogram is a set of k histogram bins, where k denotes the number of visual words (i.e., feature types). Given an observation video, each histogram bin counts the number of extracted features with the same type, ignoring their spatio-temporal locations. The histogram representation of an activity model (Aₚ,d) is computed by averaging the feature histograms of training videos while discarding features observed after the time frame d. That is, each histogram bin of the activity model (Aₚ,d) describes the expected number of corresponding visual word's occurrences, which will be observed if the activity Aₚ has progressed to the frame d.

In order to enable the efficient computation of likelihood value for any (Aₚ,d) using histograms, each activity is modeled by constructing the integral histogram thereof. Formally, an integral histogram of a video is defined as a sequence of feature histograms, H(Oₗ)=[H₁(Oₗ), h₂(Oₗ), . . . , h_{|H|}(Oₗ)] (where |H| is the number of frames of the activity video Oₗ). It is assumed that v_{w} denotes wₜₕ visual word. Then, a value of the wₜₕ histogram bin of each histogram h_{d}(Oₗ) is calculated by the following Equation 3:

h_{d}(Oₗ)[ω]=|{f|fεv_{ω} [symbol] t_{f}<d}|[Equation 3]

where f is a feature extracted from the video Oₗ and t_{f} is its temporal location. That is, each element h_{d}(Oₗ) of the integral histogram H(Oₗ) describes the histogram distribution of spatio-temporal features whose temporal locations are less than d. The integral histogram can be viewed as a temporal version of the spatial integral histogram.

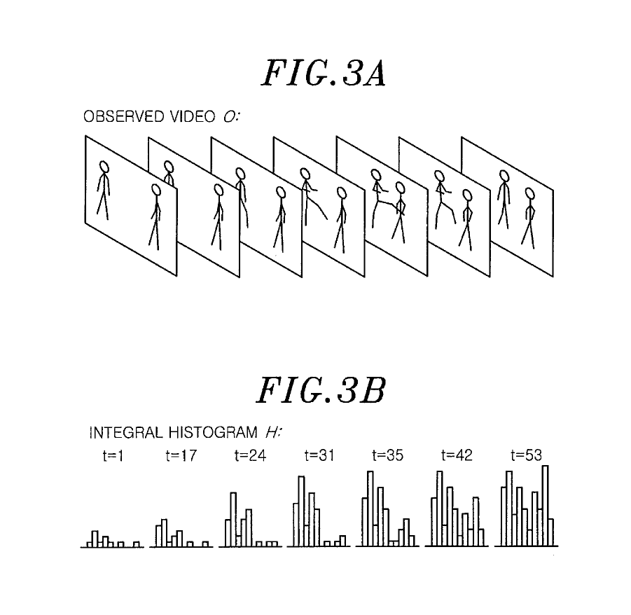

FIGS. 3A and 3B respectively illustrate examples of observed videos and integral histograms in accordance with an embodiment of the present invention.

Essentially, the integral histogram is a function of time describing how histogram values change as the observation duration increases. The integral histograms are computed for all training videos of the activity, and their mean integral histogram is used as a representation of the activity. The idea is to keep tracking changes in the visual words being observed as the activity progress. The constructed integral histograms allow for the prediction of human activities. Modeling integral histograms of activities with Gaussian distributions having a uniform variance, the problem of predicting the most probable activity A* is enumerated from Equation 4 as follows:

$$\begin{matrix}{A}^{*} = {arg}_{p} max {\sum }_{d}^{ } P ( {A}_{p} , d \vert O , t ) \\ = {arg}_{p} max \frac{{\sum }_{d}^{ } M ( {h}_{d} ( O ) , {h}_{d} ( {A}_{p} ) ) P ( t \vert d )}{{\sum }_{i}^{ } {\sum }_{d}^{ } M ( {h}_{d} ( O ) , {h}_{d} ( {A}_{i} ) ) P ( t \vert d )}\end{matrix} \\ where \\ M ( {h}_{d} ( O ) , {h}_{d} ( {A}_{i} ) ) = \frac{1}{\sqrt{2 {πσ}^{2}}} {e}^{\frac{- {( {h}_{d} ( O ) - {h}_{d} ( {A}_{i} ) )}^{2}}{2 {σ}^{2}}} \qquad [ Equation 4 ]$$

where H(Aᵢ) is the integral histogram of the activity Aᵢ, and H(O) is the integral histogram of the video ‘O’. An equal prior probability among activities is assumed, and σ² denotes the uniform variance.

The method proposed in the present invention is able to compute the activity likelihood value for all d with O (k·d*) computations given the integral histogram of the activity. The time complexity of the integral histogram construction for each activity is O(m·log m+k·d*) where m is the total number of features in training videos of the activity. That is, this approach requires significantly less amount of computations compared to the brute force method of applying previous classifiers. For instance, the brute force method of training SVMs for all d takes O (n·k·d*−r) computations where n is the number of training videos of the activity and r is the number of iterations to train a SVM.

The present invention proposes an activity recognition methodology named dynamic bag-of-words, which predicts human activities from onset videos using a sequential matching algorithm. The aforementioned integral bag-of-words is able to perform an activity prediction by analyzing ongoing status of activities, but it ignores temporal relations among extracted features.

The dynamic bag-of-words in accordance with the present invention is a new activity recognition approach that considers the sequential nature of human activities, while maintaining the bag-of-words' advantages to handle noisy observation. An activity video is a sequence of images describing human postures, and its recognition must consider the sequential structure displayed by extracted spatio-temporal features. The dynamic bag-of-words method follows the prediction formulation, i.e., Equation 2, thus measuring the posterior probability of the given video observation generated by the learned activity model. Its advantage is that the likelihood probability P(O|Aₚ,d) is computed to consider the activities' sequential structures.

It is assumed that Δd is a sub-interval of the activity model (i.e., Aₚ) that ends with d, and Δt is a sub-interval of the observed video (i.e., O) that ends with t. In addition, the observed video ‘O’ denotes more specifically as O^{t} (indicating that ‘O’ is obtained from frames 0 to t). Then, the likelihood value between the activity model and the observed video may be enumerated as following Equation 5:

$$P ( {O}^{t} \vert {A}_{p} , d ) = {\sum }_{Δ t}^{ } {\sum }_{Δ d}^{ } [ P ( {O}^{t - Δ t )} \vert {A}_{p} , d - Δ t ) P ( {O}^{Δ t} \vert {A}_{p} , Δ d ) ] \qquad [ Equation 5 ]$$

where O^{Δt} corresponds to the observations obtained during the time interval of Δt, and O^{t-Δt} corresponds to those obtained during the interval t−Δt.

This idea is to take advantage of the likelihood computed for the previous observations (i.e., P(O^{t-Δt}|Aₚ,d−Δd)) to update the likelihood of the entire observations (i.e., P(O^{t}|Aₚ,d)). This incremental likelihood computation not only enables efficient activity prediction for increasing observations, but also poses a temporal constraint that observations must match the activity model sequentially.

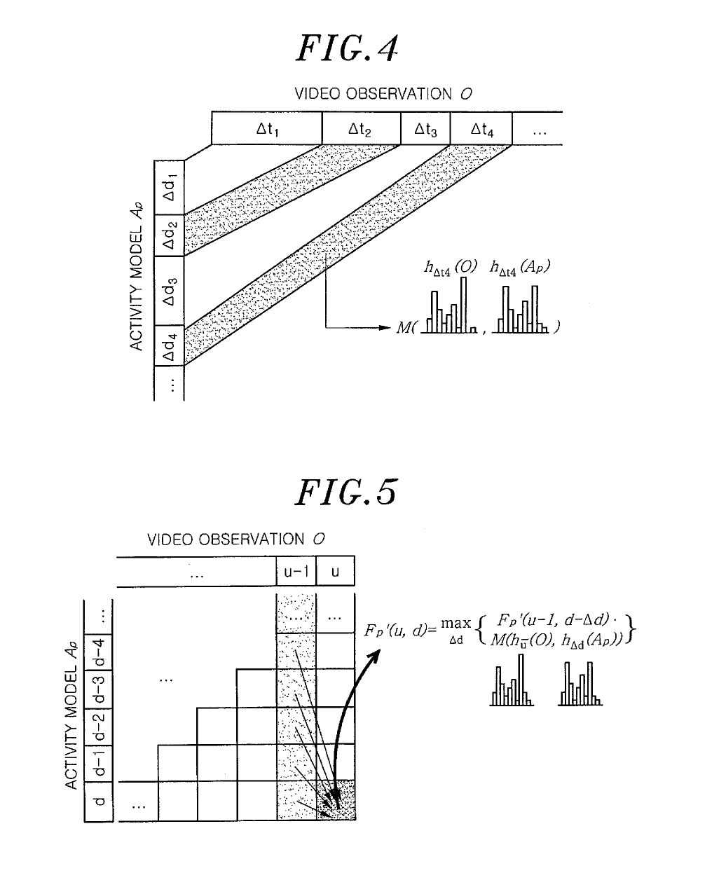

Essentially, the above-mentioned recursive equation is dividing the activity progress time interval d into a set of sub-intervals D={Δd₁, Δd₂, . . . , Δd_{q}} with varying lengths and the observed video ‘O’ into a set of sub-intervals T={Δt₁, Δt₂, . . . , Δt_{q}}. The likelihood is computed by matching q pairs of sub-intervals (Δdⱼ, Δtⱼ). That is, the above method searches for the optimal D and T that maximize the overall likelihood between two sequences, which is measured by computing similarity between the respective pairs (Δdⱼ, Δtⱼ). FIG. 4 illustrates this process.

The motivation is to divide the activity model and the observed sequence into multiple segments to find the structural similarity between them. It should be noticed that the duration of the activity model segment (i.e., Δd) that matches the new observation segment (i.e., O^{Δt}) is dynamically selected by finding the best-matching segment pairs to compute their similarity distance recursively. The segment likelihood P(O^{Δt}|Aₚ,Δd) is computed by comparing their histogram representations. That is, the bag-of-words paradigm is applied for matching the interval segments, while the segments themselves are sequentially organized based on the recursive activity prediction formulation.

The dynamic bag-of-words method in accordance with the present invention uses the integral histograms for computing the similarity (i.e., P(O^{Δt}|A,Δd)) between internal segments. The integral histograms enable efficient constructions of the histogram of the activity segment Δd and that of the video segment Δt for any possible (Δd, Δt). Assuming that [a,b] is the time interval of Δd, the histogram corresponding to Δd is calculated by the following Equation 6:

h_{Δd}(Aₚ)=h_{b}(Aₚ)−hₐ(Aₚ) [Equation 6]

where H(Aₚ) is the integral histogram of the activity Aₚ. Similarly, the histogram of Δt is computed based on the integral histogram H(O), providing hΔt(O).

Using the integral histograms, the likelihood probability calculation of our dynamic bag-of-words is represented by the following recursive equation, Equation 7. Similar to the case of integral bag-of-words method, the feature histograms of the activities are modeled with Gaussian distributions.

$${F}_{p} ( t , d ) = {\sum }_{Δ t}^{ } {\sum }_{Δ d}^{ } [ {F}_{p} ( t - Δ t , d - Δ d ) \cdot M ( {h}_{Δ t} ( O ) , {h}_{Δ d} ( {A}_{p} ) ] \qquad [ Equation 7 ]$$

where Fₚ(t,d) is equivalent to P(O^{t}|Aₚ,d).

Hereinafter, a dynamic programming implementation of the dynamic bag-of-words method is presented to find the ongoing activity from a given video. A maximum a posteriori probability (MAP) classifier of deciding which activity is most likely to occur is constructed.

Given the observation video ‘O’ with length t, the activity prediction problem of finding the most probable ongoing activity A* is expressed by the following Equation 8:

$${A}^{*} = {arg}_{p} max \frac{{\sum }_{d}^{ } {F}_{p} ( t , d ) P ( t \vert d ) P ( {A}_{p} , d )}{{\sum }_{i}^{ } {\sum }_{d}^{ } {F}_{i} ( t , d ) P ( t \vert d ) P ( {A}_{i} , d )} \qquad [ Equation 8 ]$$

That is, in order to predict the ongoing activity given an observation O^{t}, the system is required to calculate the likelihood Fₚ(t,d), i.e., Equation 8 recursively for all activity progress status d.

However, even with the integral histograms, brute force searching of all possible combinations of (Δt, Δd) for a given video of length t requires O(k*(d*)²·t²) computations. In order to find A* at each time step t, the system must compute Fₚ(t,d) for number of possible d. Furthermore, computation of each Fₚ(t,d) requires the summation of Fₚ values of all possible combinations of Δt and Δd, as described in Equation 8.

In order to make the prediction process easy to computationally handle, an algorithm that approximates the likelihood Fₚ(t,d) by allowing Δt to have a fixed duration is designed. The image frames of the observed video are divided into several segments with a fixed duration (e.g., 1 second), and the divided segments are dynamically matched with the activity segments. Assuming that u is a variable indicating a unit time duration, then the activity prediction likelihood is approximated by the following Equation 9:

$${F}_{p}^{t} ( u , d ) = {max}_{Δ d} {F}_{p}^{′} ( u - 1 , d - Δ d ) M ( {h}_{\tilde{u}} ( O ) , {h}_{Δ d} ( {A}_{p} ) ) \qquad [ Equation 9 ]$$

where ũ is a unit time interval between u−1 and u. The algorithm sequentially computes F′ₚ(u,d) for all u. At each iteration of u, the system searches for the best matching segment Δd for ũ that maximizes the function F′, as described in Equation 9. Essentially, this method interprets a video as a sequence of ordered sub-intervals (i.e., ũ) where each of the sub-intervals is represented by a histogram of features therein. As a result, F′ₚ(u,d) provides an efficient approximation of the activity prediction likelihood, while measuring how probable the observation ‘O’ is generated from the activity (i.e., Aₚ) progressed to the dₜₕ frame.

A traditional dynamic programming algorithm that corresponds to the above recursive equation is designed to calculate the likelihood. The goal is to search for the optimum activity model division (i.e., Δd) that describes the observation the best, while matching the activity model division with the observation stage by stage. FIG. 5 illustrates the process of the dynamic programming algorithm to compute the likelihood of an ongoing activity from an incomplete video. The time complexity of the algorithm is O(k·(d*)2) for each time step u, which is in general much smaller than t.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A method for human activity prediction from streaming videos, the method comprising:
extracting space-time local features from video streams containing video information related to human activities;
clustering the extracted space-time local features into multiple visual words based on the appearance of the features;
computing an activity likelihood value by modeling each activity as an integral histogram of the visual words; and
predicting the human activity based on the computed activity likelihood value.

2. The method of claim 1, wherein said extracting space-time local features includes detecting interest points with motion changes from the video streams and computing descriptors representing local movements.

3. The method of claim 1, wherein the visual words are formed from features extracted from a sample video by using a K-means clustering algorithm.

4. The method of claim 1, wherein said computing an activity likelihood value includes computing a recursive activity likelihood value by updating likelihood values of the entire observations using likelihood values computed for previous observations.

5. The method of claim 4, wherein said computing an activity likelihood value further includes computing the recursive activity likelihood value by dividing image frames of the video streams into several segments with a fixed duration and dynamically matching the divided segments with activity segments.
